(19) United States
(12) Patent Application Publication
(10) Pub. No.: US 2025/0164318 A1
(43) Pub. Date: May 22, 2025

(54) FREQUENCY ERROR CORRECTION BASED ON IDENTIFYING THE WORST THERMAL AGGRESSOR OF MULTIPLE THERMAL AGGRESSORS

(71) Applicant: QUALCOMM Incorporated, San Diego, CA (US)

(72) Inventors: Supreet HUILGOL, Santa Clara, CA (US); Qutubuddin MOHAMMED, Santa Clara, CA (US)

(21) Appl. No.: 18/516,101

(22) Filed: Nov. 21, 2023

(51) Int. Cl. G01K 1/20; G01K 1/02

(52) U.S. Cl. CPC G01K 1/20; G01K 1/026

(57) ABSTRACT

Disclosed are techniques for thermal mitigation. In an aspect, an apparatus includes one or more circuits, the one or more circuits, either alone or in combination, configured to: receive temperature readings from each of a plurality of temperature sensors of the apparatus, wherein each temperature sensor is associated with one of a plurality of thermal aggressor devices of the apparatus, output one or more first temperature readings of a first temperature sensor of the plurality of temperature sensors having a greatest thermal transient value among the plurality of thermal aggressor devices, and perform frequency error correction for the apparatus based on the one or more first temperature readings.

### BACKGROUND OF THE DISCLOSURE

### 1. Field of the Disclosure

Aspects of the disclosure relate generally to wireless technologies.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), and other technical enhancements. These enhancements, as well as the use of higher frequency bands, advances in PRS processes and technology, and high-density deployments for 5G, enable highly accurate 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, an apparatus includes one or more circuits, the one or more circuits, either alone or in combination, configured to: receive temperature readings from each of a plurality of temperature sensors of the apparatus, wherein each temperature sensor is associated with one of a plurality of thermal aggressor devices of the apparatus; output one or more first temperature readings of a first temperature sensor of the plurality of temperature sensors having a greatest thermal transient value among the plurality of thermal aggressor devices; and perform frequency error correction for the apparatus based on the one or more first temperature readings.

In an aspect, a method performed by one or more circuits includes receiving temperature readings from each of a plurality of temperature sensors of the apparatus, wherein each temperature sensor is associated with one of a plurality of thermal aggressor devices of the apparatus; outputting one or more first temperature readings of a first temperature sensor of the plurality of temperature sensors having a greatest thermal transient value among the plurality of thermal aggressor devices; and performing frequency error correction for the apparatus based on the one or more first temperature readings.

In an aspect, an apparatus includes means for receiving temperature readings from each of a plurality of temperature sensors of the apparatus, wherein each temperature sensor is associated with one of a plurality of thermal aggressor devices of the apparatus; means for outputting one or more first temperature readings of a first temperature sensor of the plurality of temperature sensors having a greatest thermal transient value among the plurality of thermal aggressor devices; and means for performing frequency error correction for the apparatus based on the one or more first temperature readings.

In an aspect, a non-transitory computer-readable medium storing computer-executable instructions that, when executed by an apparatus, cause the apparatus to: receive temperature readings from each of a plurality of temperature sensors of the apparatus, wherein each temperature sensor is associated with one of a plurality of thermal aggressor devices of the apparatus; output one or more first temperature readings of a first temperature sensor of the plurality of temperature sensors having a greatest thermal transient value among the plurality of thermal aggressor devices; and perform frequency error correction for the apparatus based on the one or more first temperature readings.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A, 2B, and 2C are simplified block diagrams of several sample aspects of components that may be employed in a user equipment (UE), a base station, and a network entity, respectively, and configured to support communications as taught herein.

FIG. 3 is a diagram illustrating an example printed circuit board (PCB) having multiple thermal aggressors, according to aspects of the disclosure.

FIG. 4 is a diagram illustrating a schematic of the example PCB illustrated in FIG. 3, according to aspects of the disclosure.

FIG. 5 is a diagram illustrating an example operation of the PCB illustrated in FIGS. 3 and 4, according to aspects of the disclosure.

FIG. 6 is a diagram illustrating an example PCB having multiple thermal aggressors coupled to multiple thermal sensors, according to aspects of the disclosure.

FIG. 7 is a diagram illustrating a schematic of the example PCB illustrated in FIG. 6, according to aspects of the disclosure.

FIG. 8 is a diagram illustrating an example operation of the PCB illustrated in FIGS. 6 and 7, according to aspects of the disclosure.

FIG. 9 is a diagram illustrating an example of the dynamic switching decision implemented by the dynamic switching block in FIG. 6, according to aspects of the disclosure.

FIG. 10 is a diagram 1000 illustrating an example PCB having multiple thermal aggressors coupled to multiple thermal sensors, according to aspects of the disclosure.

FIG. 11 is a diagram 1100 illustrating a schematic of the example PCB illustrated in FIG. 10, according to aspects of the disclosure.

FIG. 12 is a diagram illustrating an example operation of the PCB illustrated in FIGS. 10 and 11, according to aspects of the disclosure.

FIG. 13 is a diagram illustrating an example operation of the block for computing the (n+m)th derivative and the on-the-fly thermal mitigation (OTFTM) block illustrated in FIG. 10, according to aspects of the disclosure.

FIG. 14 illustrates an example method of frequency error correction, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to frequency error correction. Some aspects more specifically relate to frequency error correction based on thermal mitigation. In some examples, a plurality of thermal sensors is provided proximate to a plurality of predetermined thermal aggressors in a wireless user device, and a processing module receives data from the plurality of thermal sensors and dynamically selects data from a subset of the plurality of thermal sensors (e.g., the worst thermal aggressor(s)) to determine compensation for frequency drift caused by the plurality of thermal aggressors.

Particular aspects of the subject matter described in this disclosure can be implemented to realize one or more of the following potential advantages. In some examples, by dynamically selecting data from a subset of the plurality of thermal sensors, the described techniques can be used to compensate for the frequency drift caused by at least the subset of the plurality of thermal aggressors.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof.

Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions.

A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station.

Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver.

However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

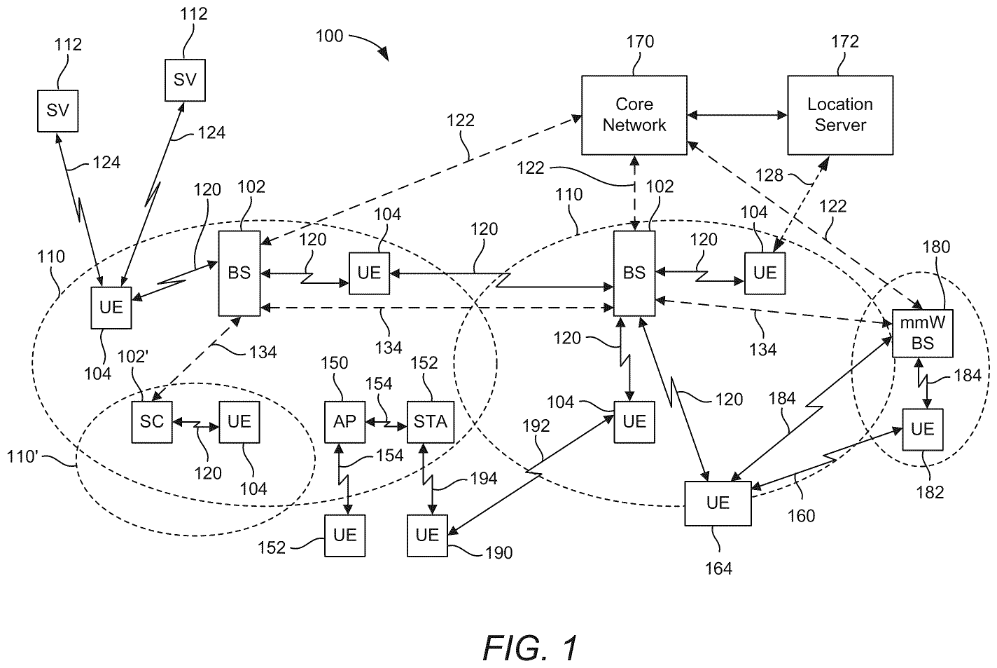

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MULTEFIRE®.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the INTERNATIONAL TELECOMMUNICATION UNION® as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (eV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102′, access point 150), etc. Thus, in some cases, UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters.

Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WI-FI DIRECT®, BLUETOOTH®, and so on.

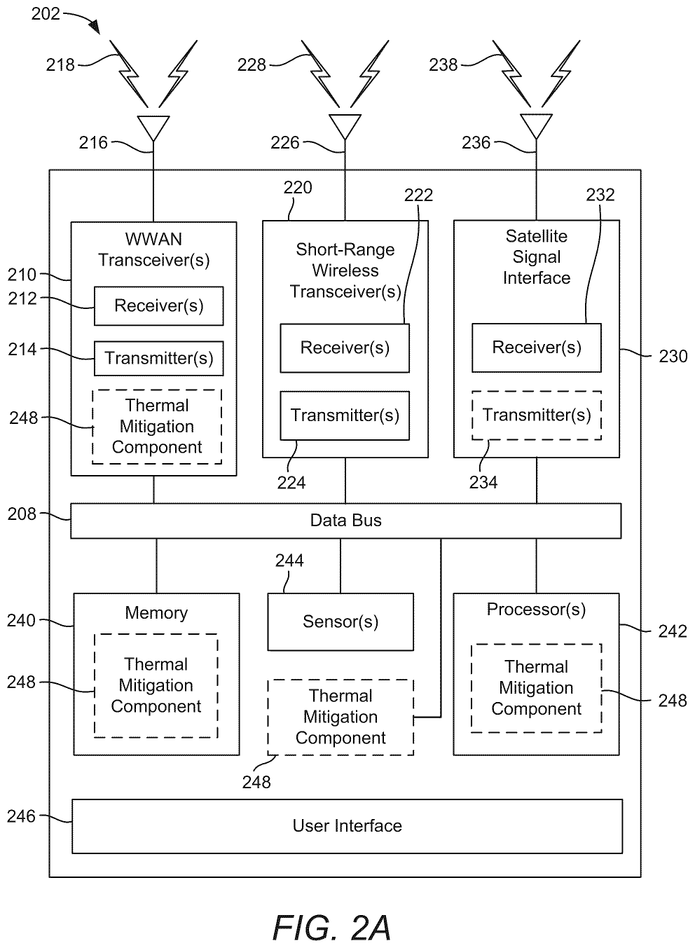

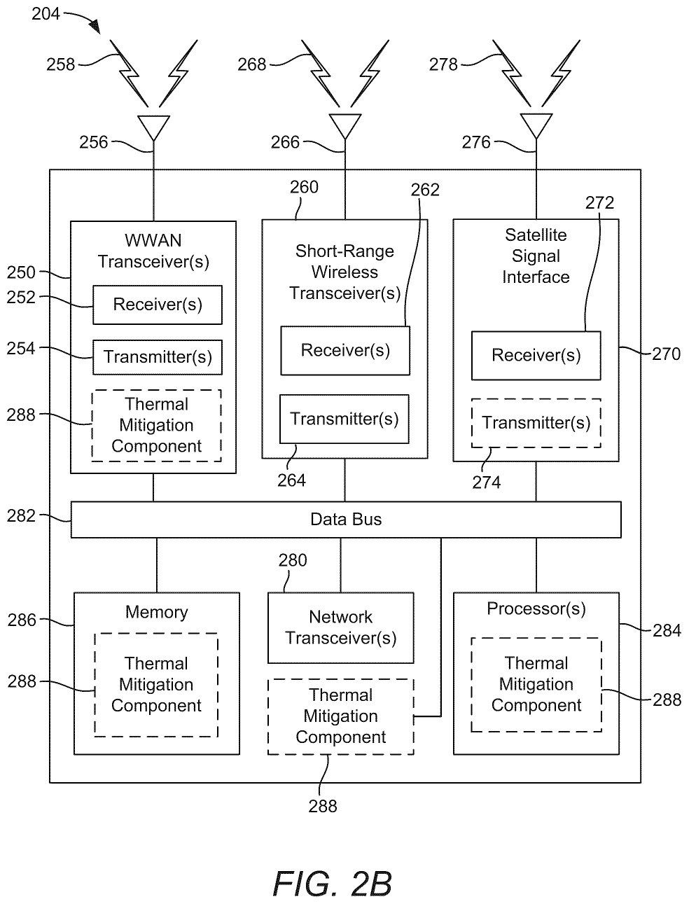

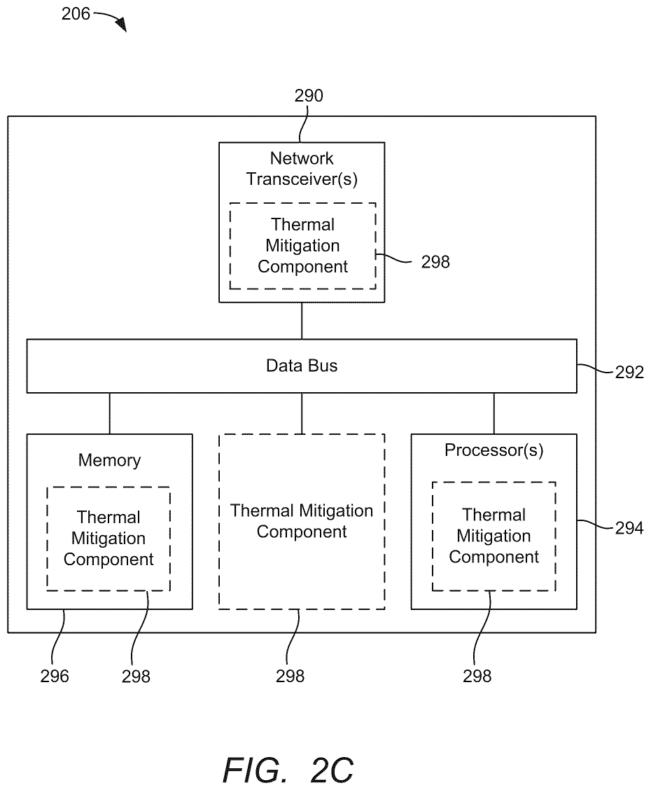

FIGS. 2A, 2B, and 2C illustrate several example components (represented by corresponding blocks) that may be incorporated into a UE 202 (which may correspond to any of the UEs described herein), a base station 204 (which may correspond to any of the base stations described herein), and a network entity 206 (which may correspond to or embody any of the network functions described herein) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 202 and the base station 204 each include one or more wireless wide area network (WWAN) transceivers 210 and 250, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 210 and 250 may each be connected to one or more antennas 216 and 256, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 210 and 250 may be variously configured for transmitting and encoding signals 218 and 258 (e.g., messages, indications, information, and so on), respectively, and, conversely, for receiving and decoding signals 218 and 258 (e.g., messages, indications, information, pilots, and so on), respectively, in accordance with the designated RAT. Specifically, the WWAN transceivers 210 and 250 include one or more transmitters 214 and 254, respectively, for transmitting and encoding signals 218 and 258, respectively, and one or more receivers 212 and 252, respectively, for receiving and decoding signals 218 and 258, respectively.

The UE 202 and the base station 204 each also include, at least in some cases, one or more short-range wireless transceivers 220 and 260, respectively. The short-range wireless transceivers 220 and 260 may be connected to one or more antennas 226 and 266, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., Wi-Fi, LTE Direct, BLUETOOTH®, ZIGBEE®, Z-WAVE®, PC5, dedicated short-range communications (DSRC), wireless access for vehicular environments (WAVE), near-field communication (NFC), ultra-wideband (UWB), etc.) over a wireless communication medium of interest. The short-range wireless transceivers 220 and 260 may be variously configured for transmitting and encoding signals 228 and 268 (e.g., messages, indications, information, and so on), respectively, and, conversely, for receiving and decoding signals 228 and 268 (e.g., messages, indications, information, pilots, and so on), respectively, in accordance with the designated RAT. Specifically, the short-range wireless transceivers 220 and 260 include one or more transmitters 224 and 264, respectively, for transmitting and encoding signals 228 and 268, respectively, and one or more receivers 222 and 262, respectively, for receiving and decoding signals 228 and 268, respectively. As specific examples, the short-range wireless transceivers 220 and 260 may be Wi-Fi transceivers, BLUETOOTH® transceivers, ZIGBEE® and/or Z-WAVE® transceivers, NFC transceivers, UWB transceivers, or vehicle-to-vehicle (V2V) and/or vehicle-to-everything (V2X) transceivers.

The UE 202 and the base station 204 also include, at least in some cases, satellite signal interfaces 230 and 270, which each include one or more satellite signal receivers 232 and 272, respectively, and may optionally include one or more satellite signal transmitters 234 and 274, respectively. In some cases, the base station 204 may be a terrestrial base station that may communicate with space vehicles (e.g., space vehicles 112) via the satellite signal interface 270. In other cases, the base station 204 may be a space vehicle (or other non-terrestrial entity) that uses the satellite signal interface 270 to communicate with terrestrial networks and/or other space vehicles.

The satellite signal receivers 232 and 272 may be connected to one or more antennas 236 and 276, respectively, and may provide means for receiving and/or measuring satellite positioning/communication signals 238 and 278, respectively. Where the satellite signal receiver(s) 232 and 272 are satellite positioning system receivers, the satellite positioning/communication signals 238 and 278 may be global positioning system (GPS) signals, global navigation satellite system (GLONASS) signals, Galileo signals, Beidou signals, Indian Regional Navigation Satellite System (NAVIC), Quasi-Zenith Satellite System (QZSS) signals, etc. Where the satellite signal receiver(s) 232 and 272 are non-terrestrial network (NTN) receivers, the satellite positioning/communication signals 238 and 278 may be communication signals (e.g., carrying control and/or user data) originating from a 5G network. The satellite signal receiver(s) 232 and 272 may comprise any suitable hardware and/or software for receiving and processing satellite positioning/communication signals 238 and 278, respectively. The satellite signal receiver(s) 232 and 272 may request information and operations as appropriate from the other systems, and, at least in some cases, perform calculations to determine locations of the UE 202 and the base station 204, respectively, using measurements obtained by any suitable satellite positioning system algorithm.

The optional satellite signal transmitter(s) 234 and 274, when present, may be connected to the one or more antennas 236 and 276, respectively, and may provide means for transmitting satellite positioning/communication signals 238 and 278, respectively. Where the satellite signal transmitter(s) 274 are satellite positioning system transmitters, the satellite positioning/communication signals 278 may be GPS signals, GLONASS® signals, Galileo signals, Beidou signals, NAVIC, QZSS signals, etc. Where the satellite signal transmitter(s) 234 and 274 are NTN transmitters, the satellite positioning/communication signals 238 and 278 may be communication signals (e.g., carrying control and/or user data) originating from a 5G network. The satellite signal transmitter(s) 234 and 274 may comprise any suitable hardware and/or software for transmitting satellite positioning/communication signals 238 and 278, respectively. The satellite signal transmitter(s) 234 and 274 may request information and operations as appropriate from the other systems.

The base station 204 and the network entity 206 each include one or more network transceivers 280 and 290, respectively, providing means for communicating (e.g., means for transmitting, means for receiving, etc.) with other network entities (e.g., other base stations 204, other network entities 206). For example, the base station 204 may employ the one or more network transceivers 280 to communicate with other base stations 204 or network entities 206 over one or more wired or wireless backhaul links. As another example, the network entity 206 may employ the one or more network transceivers 290 to communicate with one or more base station 204 over one or more wired or wireless backhaul links, or with other network entities 206 over one or more wired or wireless core network interfaces.

A transceiver may be configured to communicate over a wired or wireless link. A transceiver (whether a wired transceiver or a wireless transceiver) includes transmitter circuitry (e.g., transmitters 214, 224, 254, 264) and receiver circuitry (e.g., receivers 212, 222, 252, 262). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 280 and 290 in some implementations) may be coupled to one or more wired network interface ports. Wireless transmitter circuitry (e.g., transmitters 214, 224, 254, 264) may include or be coupled to a plurality of antennas (e.g., antennas 216, 226, 256, 266), such as an antenna array, that permits the respective apparatus (e.g., UE 202, base station 204) to perform transmit “beamforming,” as described herein. Similarly, wireless receiver circuitry (e.g., receivers 212, 222, 252, 262) may include or be coupled to a plurality of antennas (e.g., antennas 216, 226, 256, 266), such as an antenna array, that permits the respective apparatus (e.g., UE 202, base station 204) to perform receive beamforming, as described herein. In an aspect, the transmitter circuitry and receiver circuitry may share the same plurality of antennas (e.g., antennas 216, 226, 256, 266), such that the respective apparatus can only receive or transmit at a given time, not both at the same time. A wireless transceiver (e.g., WWAN transceivers 210 and 250, short-range wireless transceivers 220 and 260) may also include a network listen module (NLM) or the like for performing various measurements.

As used herein, the various wireless transceivers (e.g., transceivers 210, 220, 250, and 260, and network transceivers 280 and 290 in some implementations) and wired transceivers (e.g., network transceivers 280 and 290 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 202) and a base station (e.g., base station 204) will generally relate to signaling via a wireless transceiver.

The UE 202, the base station 204, and the network entity 206 also include other components that may be used in conjunction with the operations as disclosed herein. The UE 202, the base station 204, and the network entity 206 include one or more processors 242, 284, and 294, respectively, for providing functionality relating to, for example, wireless communication, and for providing other processing functionality. The processors 242, 284, and 294 may therefore provide means for processing, such as means for determining, means for calculating, means for receiving, means for transmitting, means for indicating, etc. In an aspect, the processors 242, 284, and 294 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 202, the base station 204, and the network entity 206 include memory circuitry implementing memories 240, 286, and 296 (e.g., each including a memory device), respectively, for maintaining information (e.g., information indicative of reserved resources, thresholds, parameters, and so on). The memories 240, 286, and 296 may therefore provide means for storing, means for retrieving, means for maintaining, etc. In some cases, the UE 202, the base station 204, and the network entity 206 may include thermal mitigation component 248, 288, and 298, respectively. The thermal mitigation component 248, 288, and 298 may be hardware circuits that are part of or coupled to the processors 242, 284, and 294, respectively, that, when executed, cause the UE 202, the base station 204, and the network entity 206 to perform the functionality described herein.

In other aspects, the thermal mitigation component 248, 288, and 298 may be external to the processors 242, 284, and 294 (e.g., part of a modem processing system, integrated with another processing system, etc.). Alternatively, the thermal mitigation component 248, 288, and 298 may be memory modules stored in the memories 240, 286, and 296, respectively, that, when executed by the processors 242, 284, and 294 (or a modem processing system, another processing system, etc.), cause the UE 202, the base station 204, and the network entity 206 to perform the functionality described herein. FIG. 2A illustrates possible locations of the thermal mitigation component 248, which may be, for example, part of the one or more WWAN transceivers 210, the memory 240, the one or more processors 242, or any combination thereof, or may be a standalone component.

FIG. 2B illustrates possible locations of the thermal mitigation component 288, which may be, for example, part of the one or more WWAN transceivers 250, the memory 286, the one or more processors 284, or any combination thereof, or may be a standalone component. FIG. 2C illustrates possible locations of the thermal mitigation component 298, which may be, for example, part of the one or more network transceivers 290, the memory 296, the one or more processors 294, or any combination thereof, or may be a standalone component.

The UE 202 may include one or more sensors 244 coupled to the one or more processors 242 to provide means for sensing or detecting movement and/or orientation information that is independent of motion data derived from signals received by the one or more WWAN transceivers 210, the one or more short-range wireless transceivers 220, and/or the satellite signal interface 230. By way of example, the sensor(s) 244 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 244 may include a plurality of different types of devices and combine their outputs in order to provide motion information. For example, the sensor(s) 244 may use a combination of a multi-axis accelerometer and orientation sensors to provide the ability to compute positions in two-dimensional (2D) and/or three-dimensional (3D) coordinate systems.

In addition, the UE 202 includes a user interface 246 providing means for providing indications (e.g., audible and/or visual indications) to a user and/or for receiving user input (e.g., upon user actuation of a sensing device such a keypad, a touch screen, a microphone, and so on). Although not shown, the base station 204 and the network entity 206 may also include user interfaces.

Referring to the one or more processors 284 in more detail, in the downlink, IP packets from the network entity 206 may be provided to the processor 284. The one or more processors 284 may implement functionality for an RRC layer, a packet data convergence protocol (PDCP) layer, a radio link control (RLC) layer, and a medium access control (MAC) layer. The one or more processors 284 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer protocol data units (PDUs), error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 254 and the receiver 252 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 254 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 202. Each spatial stream may then be provided to one or more different antennas 256. The transmitter 254 may modulate an RF carrier with a respective spatial stream for transmission.

At the UE 202, the receiver 212 receives a signal through its respective antenna(s) 216. The receiver 212 recovers information modulated onto an RF carrier and provides the information to the one or more processors 242. The transmitter 214 and the receiver 212 implement Layer-1 functionality associated with various signal processing functions. The receiver 212 may perform spatial processing on the information to recover any spatial streams destined for the UE 202. If multiple spatial streams are destined for the UE 202, they may be combined by the receiver 212 into a single OFDM symbol stream. The receiver 212 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 204. These soft decisions may be based on channel estimates computed by a channel estimator. The soft decisions are then decoded and de-interleaved to recover the data and control signals that were originally transmitted by the base station 204 on the physical channel. The data and control signals are then provided to the one or more processors 242, which implements Layer-3 (L3) and Layer-2 (L2) functionality.

In the downlink, the one or more processors 242 provides demultiplexing between transport and logical channels, packet reassembly, deciphering, header decompression, and control signal processing to recover IP packets from the core network. The one or more processors 242 are also responsible for error detection.

Similar to the functionality described in connection with the downlink transmission by the base station 204, the one or more processors 242 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 204 may be used by the transmitter 214 to select the appropriate coding and modulation schemes, and to facilitate spatial processing. The spatial streams generated by the transmitter 214 may be provided to different antenna(s) 216. The transmitter 214 may modulate an RF carrier with a respective spatial stream for transmission.

The uplink transmission is processed at the base station 204 in a manner similar to that described in connection with the receiver function at the UE 202. The receiver 252 receives a signal through its respective antenna(s) 256. The receiver 252 recovers information modulated onto an RF carrier and provides the information to the one or more processors 284.

In the uplink, the one or more processors 284 provides demultiplexing between transport and logical channels, packet reassembly, deciphering, header decompression, control signal processing to recover IP packets from the UE 202. IP packets from the one or more processors 284 may be provided to the core network. The one or more processors 284 are also responsible for error detection.

For convenience, the UE 202, the base station 204, and/or the network entity 206 are shown in FIGS. 2A, 2B, and 2C as including various components that may be configured according to the various examples described herein. It will be appreciated, however, that the illustrated components may have different functionality in different designs. In particular, various components in FIGS. 2A to 2C are optional in alternative configurations and the various aspects include configurations that may vary due to design choice, costs, use of the device, or other considerations. For example, in case of FIG. 2A, a particular implementation of UE 202 may omit the WWAN transceiver(s) 210 (e.g., a wearable device or tablet computer or personal computer (PC) or laptop may have Wi-Fi and/or BLUETOOTH® capability without cellular capability), or may omit the short-range wireless transceiver(s) 220 (e.g., cellular-only, etc.), or may omit the satellite signal interface 230, or may omit the sensor(s) 244, and so on. In another example, in case of FIG. 2B, a particular implementation of the base station 204 may omit the WWAN transceiver(s) 250 (e.g., a Wi-Fi “hotspot” access point without cellular capability), or may omit the short-range wireless transceiver(s) 260 (e.g., cellular-only, etc.), or may omit the satellite signal interface 270, and so on. For brevity, illustration of the various alternative configurations is not provided herein, but would be readily understandable to one skilled in the art.

The various components of the UE 202, the base station 204, and the network entity 206 may be communicatively coupled to each other over data buses 208, 282, and 292, respectively. In an aspect, the data buses 208, 282, and 292 may form, or be part of, a communication interface of the UE 202, the base station 204, and the network entity 206, respectively. For example, where different logical entities are embodied in the same device (e.g., gNB and location server functionality incorporated into the same base station 204), the data buses 208, 282, and 292 may provide communication between them.

The components of FIGS. 2A, 2B, and 2C may be implemented in various ways. In some implementations, the components of FIGS. 2A, 2B, and 2C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 210 to 246 may be implemented by processor and memory component(s) of the UE 202 (e.g., by execution of appropriate code and/or by appropriate configuration of processor components). Similarly, some or all of the functionality represented by blocks 250 to 288 may be implemented by processor and memory component(s) of the base station 204 (e.g., by execution of appropriate code and/or by appropriate configuration of processor components). Also, some or all of the functionality represented by blocks 290 to 298 may be implemented by processor and memory component(s) of the network entity 206 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 202, base station 204, network entity 206, etc., such as the processors 242, 284, 294, the transceivers 210, 220, 250, and 260, the memories 240, 286, and 296, the thermal mitigation component 248, 288, and 298, etc.

In some designs, the network entity 206 may be implemented as a core network component. In other designs, the network entity 206 may be distinct from a network operator or operation of the cellular network infrastructure (e.g., NG RAN 220 and/or 5GC 210/260). For example, the network entity 206 may be a component of a private network that may be configured to communicate with the UE 202 via the base station 204 or independently from the base station 204 (e.g., over a non-cellular communication link, such as Wi-Fi).

At a high level, any thermal aggressor in a user device (e.g., UE 202) can impact global navigation satellite system (GNSS) performance (e.g., the performance of the satellite signal receiver(s) 232) by causing a frequency drift in the crystal that makes frequency error correction challenging. For example, the heat from a thermal aggressor can cause GNSS cycle slips, resulting in satellite data decoding errors that in turn can impact the GNSS performance. This issue becomes more complicated when there are multiple thermal aggressors in the device and all (or most) are being activated or being used at the same or different time instances because it is difficult to gauge the true worst thermal transient at the right time instance to perform frequency error correction. The extent of the problem depends on the complexity of the printed circuit board (PCB) layout and the relative locations and behaviors of the thermal aggressor components in the layout with respect to the crystal. This problem is relevant to all chipset manufacturers that manufacture user devices that include GNSS-based functionality.

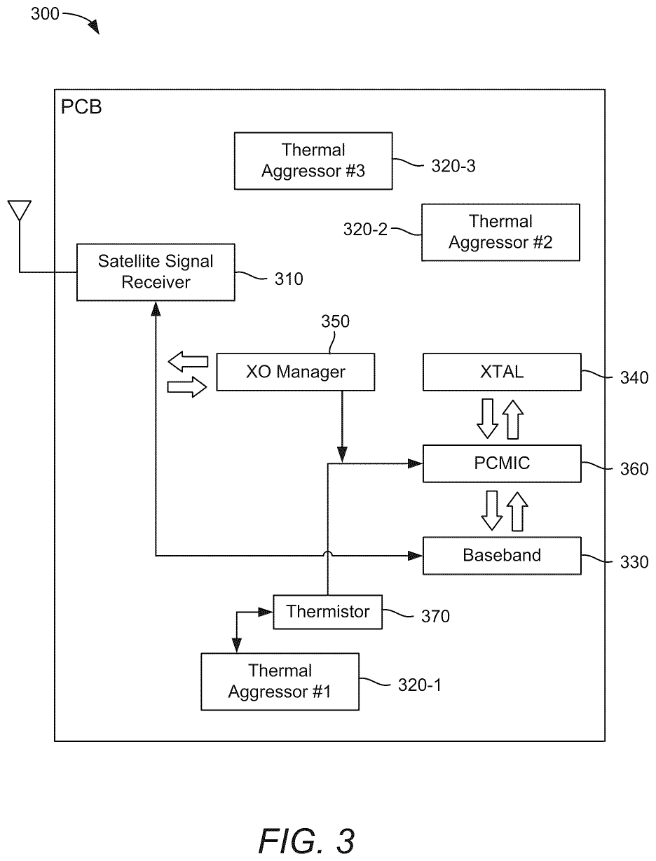

FIG. 3 is a diagram illustrating an example PCB 300 having multiple thermal aggressors, according to aspects of the disclosure. The PCB 300 may be a PCB of the UE 202, for example. The PCB 300 includes a satellite signal receiver 310 (which may correspond to the satellite signal receiver(s) 232), multiple thermal aggressors 320 (illustrated as a first thermal aggressor 310-1, a second thermal aggressor 310-2, and a third thermal aggressor 310-3), and a baseband 330 coupled to the satellite signal receiver 310. The PCB 300 further includes a crystal (XTAL) 340 (which may be, for example, a 38.4 MHz or 76.8 MHz crystal), a crystal oscillator (XO) manager 350 that handles XO error compensation, and a power and clock management integrated circuit (PCMIC) 360 (also referred to as a power management integrated circuit (PMIC)).

The thermal aggressors 320 may be any component in the PCB 300 that can thermally impact the XTAL 340 and degrade performance of the satellite signal receiver 310. For example, the thermal aggressors 320 may include components or circuits that generate heat, and/or an energy storage device (e.g., a battery) that can be heated up during charging, etc. In some implementations, the thermal aggressors 320 may include one or more application processors, one or more power amplifiers, one or more baseband processing units, one or more cameras, and/or one or more display units. The baseband 330 may also be a thermal aggressor. There can be many thermal aggressors 320 in a PCB 300, but only three are illustrated in FIG. 3 for the sake of simplicity.

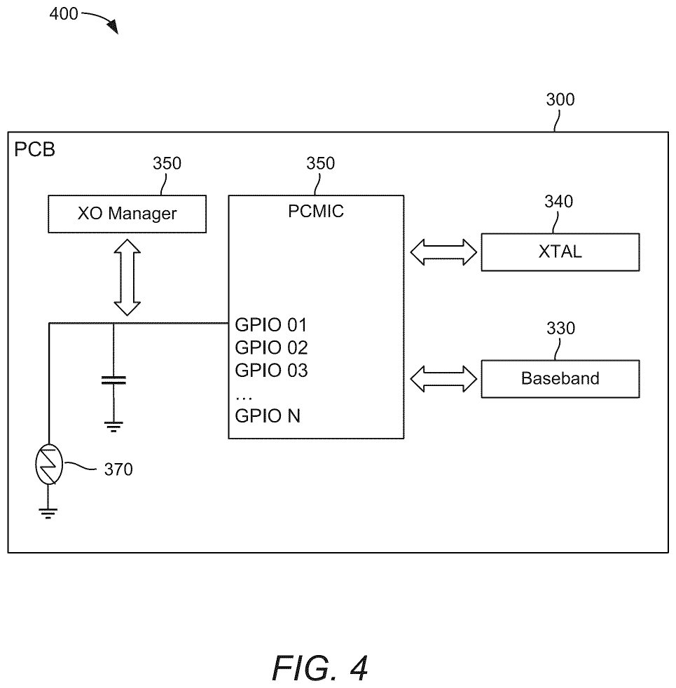

FIG. 4 is a diagram 400 illustrating a schematic of the example PCB 300 illustrated in FIG. 3, according to aspects of the disclosure. In the example of FIG. 4, the PCMIC 350 has N general-purpose input/output (GPIO) ports, one of which is connected to the thermal sensor (thermistor) 370.

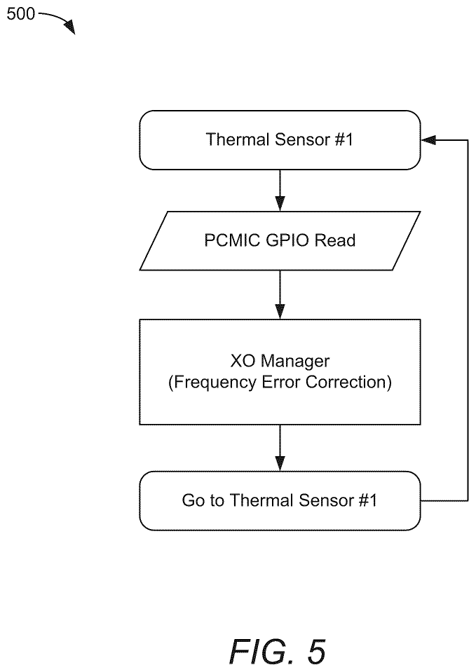

FIG. 5 is a diagram 500 illustrating an example operation of the PCB 300 illustrated in FIGS. 3 and 4, according to aspects of the disclosure. Currently, to enable the XO manager 350 to perform frequency error correction for the satellite signal receiver 310, a thermal aggressor 320 is predetermined or identified based on its thermal characteristics, and a thermal sensor is placed close to it to provide the thermal profile of the thermal aggressor 320 to the XO manager 350 for frequency error correction. A conventional PCMIC 360 does not read multiple thermal sensor outputs at a given time instance and feed them to the XO manager 350. As such, only one predetermined thermal sensor's output is used as an input to the XO manager 350 for frequency error correction. In the example of FIGS. 3-5, the first thermal aggressor 320-1 has been identified as the worst thermal aggressor, and therefore, a thermal sensor (illustrated as a thermistor 370) has been placed near the first thermal aggressor 320-1. The PCMIC 360 reads the output of the thermistor 370 and provides it to the XO manager 350 for frequency error correction.

In the existing solution, as illustrated in FIGS. 3 and 4, there is a limitation on detecting the true worst thermal transient. The true worst thermal transient could be the result of a corner case thermal scenario whose thermal characteristics cannot be completely determined due to the absence of missing thermal sensors close to each of the known thermal aggressors. That is, a particular thermal aggressor may normally cause the worst thermal transient, but in some (corner) cases, such as when multiple thermal aggressors are operating concurrently that normally do not, or a thermal aggressor is operating at a load at which it normally does not, or the like, a different thermal aggressor may cause the worst thermal transient. In such cases, the wrong thermal aggressor will be used to perform frequency error correction, which will impact the user navigation experience.

In addition, it may sometimes cost multiple spins of a PCB to correctly determine the most thermally aggressive component on an actual physical PCB to place a thermal sensor close to it for thermal detection and frequency error correction. And even so, this process can still miss the corner case thermal scenarios described above.

The present disclosure provides techniques to accurately detect the true worst thermal transient and perform appropriate frequency error correction by using additional thermal sensors and a dynamic switching solution. These techniques can significantly improve GNSS performance and, thereby, user navigation performance.

In the disclosed techniques, a thermal sensor (e.g., a thermistor) is placed near each of the known thermal aggressors. All of the thermal sensors are activated and read at the same time through different GPIOs. Circuitry is provided for dynamically switching to the thermal sensor output of the worst thermal aggressor, which can be used as the input to the XO manager for frequency error correction. The dynamic switching decision may be based on the thermal characteristics of each thermal aggressor, such as the temperature in degrees, the thermal slope in degrees per second (d/s), the thermal acceleration in degrees per second per second (d/s/s), and so on. As described further below, other parameters may also or alternatively be used as an input for the dynamic switching decision.

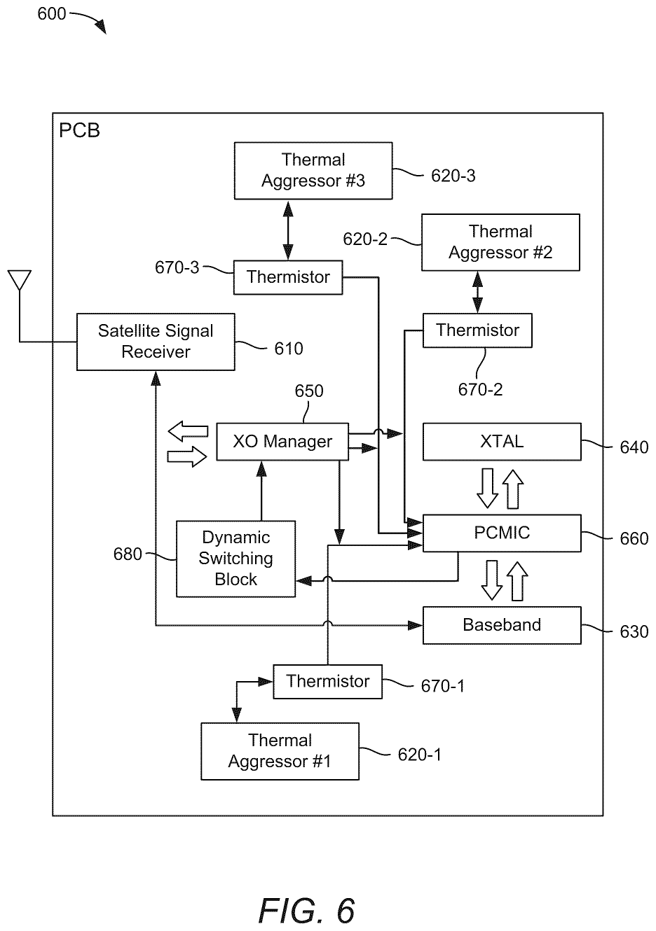

FIG. 6 is a diagram illustrating an example PCB 600 having multiple thermal aggressors coupled to multiple thermal sensors, according to aspects of the disclosure. The PCB 600 may be a PCB of the UE 202, for example. Like the PCB 300 in FIG. 3, the PCB 600 includes a satellite signal receiver 610 (which may correspond to the satellite signal receiver(s) 232), multiple thermal aggressors 620 (illustrated as a first thermal aggressor 610-1, a second thermal aggressor 610-2, and a third thermal aggressor 610-3), and a baseband 630 coupled to the satellite signal receiver 610. The PCB 600 further includes an XTAL 640 (which may be, for example, a 38.4 MHz or 76.8 MHz crystal), an XO manager 650 that handles XO error compensation, and a PCMIC 660.

Unlike the PCB 300 illustrated in FIG. 3, the PCB 600 includes a thermal sensor near each of the known thermal aggressors 620, illustrated as a first thermistor 670-1, a second thermistor 670-2, and a third thermistor 670-3. The PCB 600 further includes a dynamic switching block 680 for dynamically switching to the worst thermal sensor output as an input for frequency error correction depending on various characteristics of the thermal aggressor 620, such as temperature, slope, acceleration, etc. The dynamic switching block 680 may be a separate circuit or may be logic/circuitry incorporated into the PCMIC 660 or the XO manager 650.

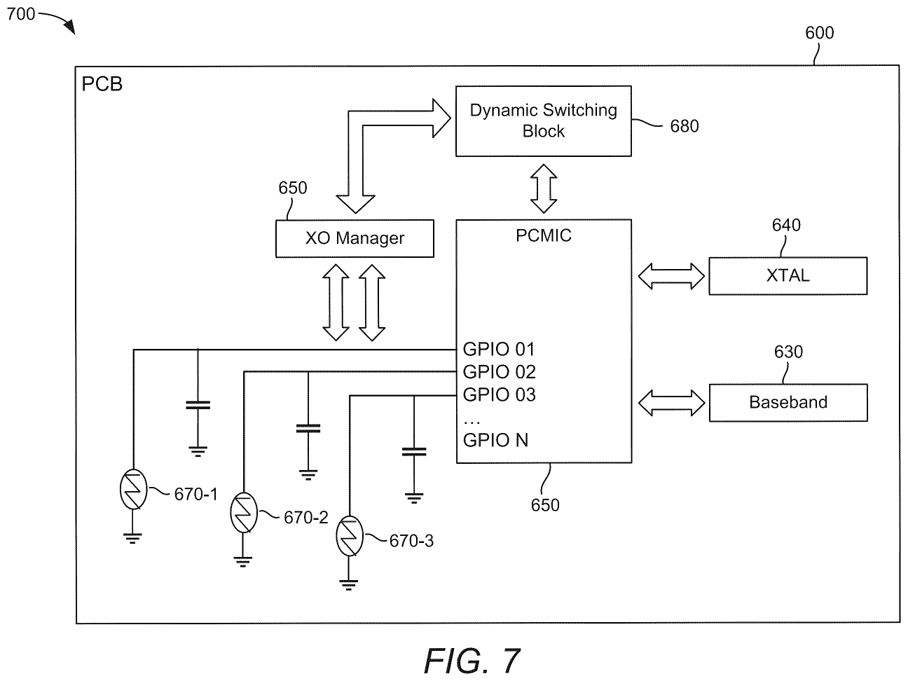

FIG. 7 is a diagram 700 illustrating a schematic of the example PCB 600 illustrated in FIG. 6, according to aspects of the disclosure. In the example of FIG. 7, the PCMIC 650 has N GPIO ports, a subset of which (e.g., three) is connected to the thermistors 670. Note that while FIGS. 6 and 7 illustrate three thermal aggressors 620 and corresponding thermistors 670, as will be appreciated, there may be more or fewer than three thermal aggressors 620 and corresponding thermistors 670.

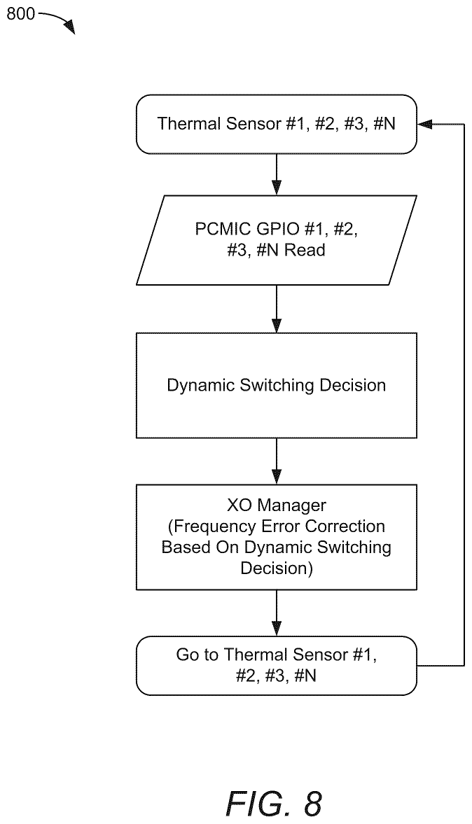

FIG. 8 is a diagram 800 illustrating an example operation of the PCB 600 illustrated in FIGS. 6 and 7, according to aspects of the disclosure. As shown in FIGS. 6-8, the PCMIC 660 reads the output from the multiple thermistors 670 at a given time instance through, for example, different GPIOs (as shown in FIG. 6). That is, the output of more than one thermistor 670 is read at a time and, based on a dynamic switching decision implemented by the dynamic switching block 680, the XO manager 650 switches to the thermistor 670 with the true worst thermal transient (or worst thermal aggressor) for frequency error correction.

The following table is an example dynamic switching decision table.

TABLE 1

| Thermal | Temperature | Thermal | Thermal |
|---|---|---|---|
| Aggressor ID | (degrees) | Slope (d/s) | Acceleration (d/s/s) |
| 1 | High | High | High |
| 2 | Low | Low | Low |
| 3 | Low | Low | Low |
| . . . | . . . | . . . | . . . |
| N | Low | Low | Low |

The above table shows that thermal aggressor 1 has the worst thermal transients (e.g., temperature, slope, acceleration), and as such, the dynamic switching block 680 will select thermal sensor 1 and use its output for frequency error correction while disregarding all other thermal sensors' outputs.

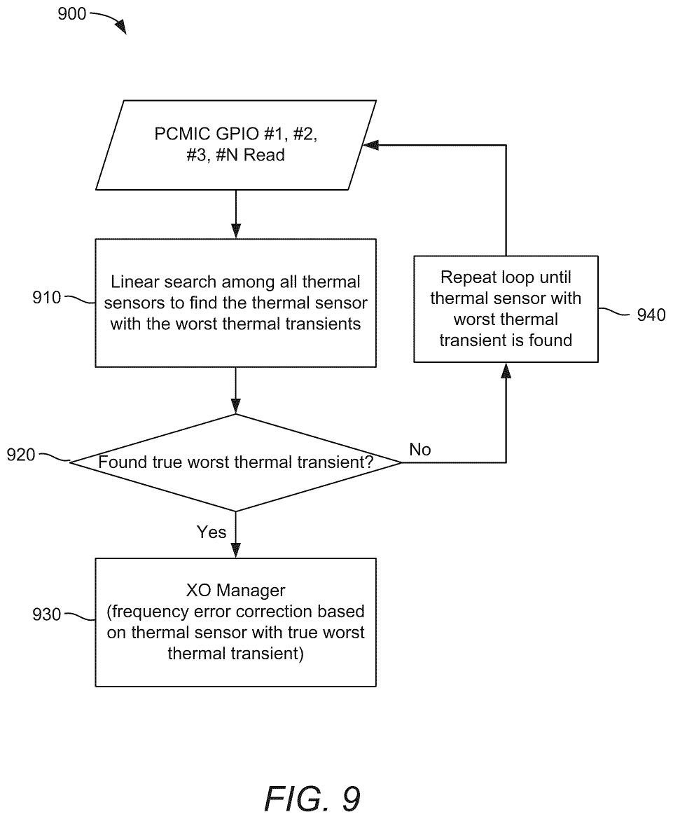

FIG. 9 is a diagram 900 illustrating an example of the dynamic switching decision implemented by the dynamic switching block 680 in FIG. 6, according to aspects of the disclosure. As shown in FIG. 9, at block 910, the dynamic switching block 680 performs a linear search among all thermal sensors (e.g., thermistors 670) to find the thermal sensor with the worst thermal transients. At block 920, the dynamic switching block 680 determines whether the true worst thermal transient has been found. If it has, then at block 930, the XO manager (e.g., XO manager 650) performs frequency error correction based on the thermal sensor with the true worst thermal transient. If it has not, then at block 940, the dynamic switching block 680 repeats the loop until the thermal sensor with the worst thermal transient is found at block 920.

As will be appreciated, by deploying a thermal sensor close to each known thermal aggressor and implementing the dynamic switching decision, the XO manager is fed with the true worst thermal transient, thereby improving the accuracy of the frequency error correction.

An issue with the foregoing technique is the challenge of precisely gauging the magnitude of the thermal transients on the XTAL in the presence of multiple thermal aggressors. In addition, when the thermal aggression increases, the impact on the XTAL (and hence the frequency error) continues to rise. The issue becomes complicated when two or more of the thermal aggressors are indicating the same magnitude of thermal transients in terms of the XO thermal slope (ds), XO thermal acceleration (d/s/s), etc., making it difficult to identify the true worst thermal transient.

In the technique described above, the dynamic switching block 680 may not be able to distinguish the true worst thermal transient when two or more thermal aggressors are indicating the same magnitude of thermal aggression. The true worst thermal transient could be the result of a corner case thermal scenario where the thermal characteristics of a thermal aggressor cannot be completely determined. As such, it would be beneficial to provide on-the-fly thermal mitigation (OTFTM) to dynamically recover from XO thermal transients and thereby reduce the impact of frequency error on the XTAL

Accordingly, the present disclosure further provides techniques to accurately detect the true worst thermal transient from the appropriate thermal aggressor when two or more thermal aggressors indicate similar magnitudes of aggression. This can be implemented by computing the (n+m)th derivative of a thermal characteristic (e.g., thermal slope) of a thermal aggressor, where n is the thermal characteristic and m is a derivative number of the thermal characteristic for all possible values of m.

For example, where the thermal characteristic is thermal slope, then if the thermal slope (d/s) is of similar (e.g., within a threshold) magnitude for two thermal aggressors, then the true worst thermal transient decision can be determined based on the thermal acceleration (d/s/s), which is the second derivative of thermal slope. Similarly, if the thermal acceleration is of similar (e.g., within a threshold) magnitude for two thermal aggressors, then the true worst thermal transient decision can be based on thermal jerk (d/s/s/s), which is the third derivative of thermal slope.

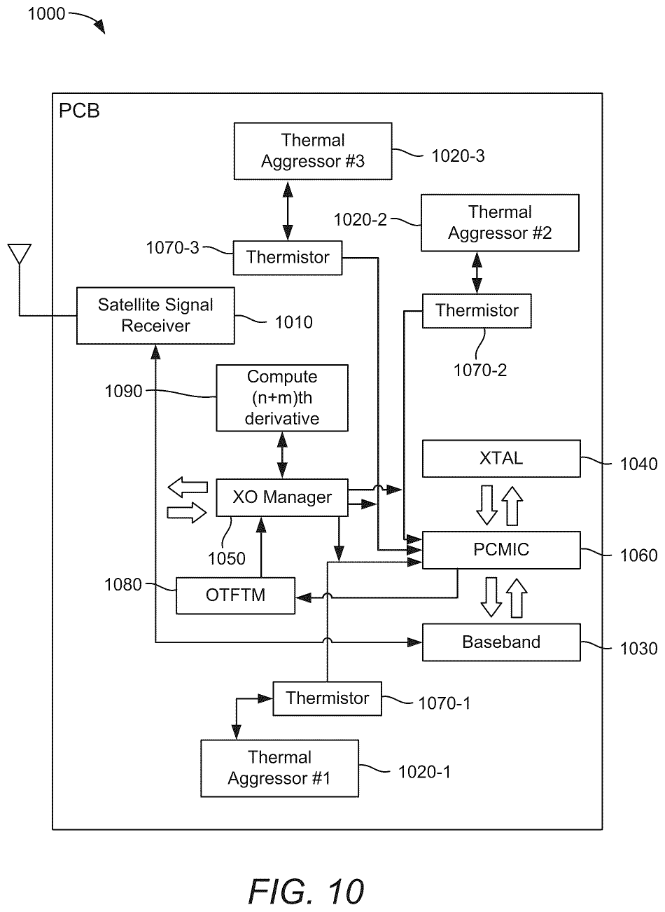

FIG. 10 is a diagram illustrating an example PCB 1000 having multiple thermal aggressors coupled to multiple thermal sensors, according to aspects of the disclosure. The PCB 1000 may be a PCB of the UE 202, for example. Like the PCB 600 in FIG. 6, the PCB 1000 includes a satellite signal receiver 1010 (which may correspond to the satellite signal receiver(s) 232), multiple thermal aggressors 1020 (illustrated as a first thermal aggressor 1010-1, a second thermal aggressor 1010-2, and a third thermal aggressor 1010-3), and a baseband 1030 coupled to the satellite signal receiver 1010. The PCB 1000 further includes an XTAL 1040 (which may be, for example, a 38.4 MHz or 76.8 MHz crystal), an XO manager 1050 that handles XO error compensation, and a PCMIC 1060.

Like the PCB 600 illustrated in FIG. 6, the PCB 1000 includes a thermal sensor near each of the known thermal aggressors 1020, illustrated as a first thermistor 1070-1, a second thermistor 1070-2, and a third thermistor 1070-3. Unlike the PCB 600, the PCB 1000 includes an on-the-fly thermal mitigation (OTFTM) block 1080 and block 1090 for computing the (n+m)th derivative of a thermal characteristic (e.g., thermal slope). The OTFTM block 1080 and/or the block 1090 for computing the (n+m)th derivative may be separate circuits or may be logic/circuitry incorporated into the PCMIC 1060 or the XO manager 1050, for example.

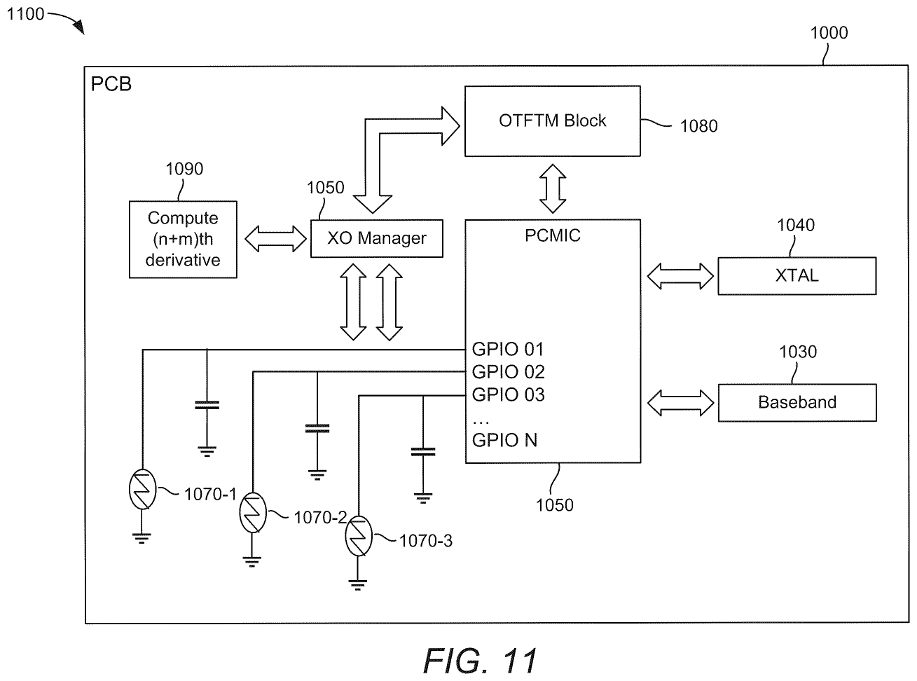

FIG. 11 is a diagram 1100 illustrating a schematic of the example PCB 1000 illustrated in FIG. 10, according to aspects of the disclosure. In the example of FIG. 11, the PCMIC 1050 has N GPIO ports, a subset of which (e.g., three) is connected to the thermistors 1070. Note that while FIGS. 10 and 11 illustrate three thermal aggressors 1020 and corresponding thermistors 1070, as will be appreciated, there may be more or fewer than three thermal aggressors 1020 and corresponding thermistors 1070.

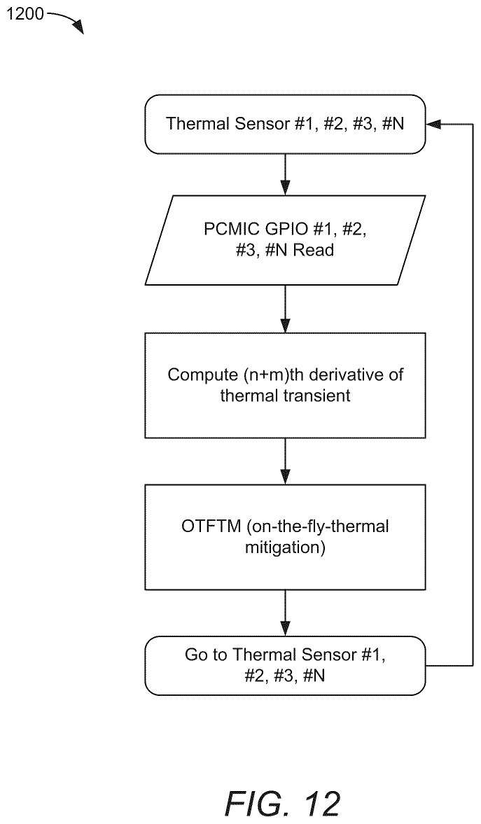

FIG. 12 is a diagram 1200 illustrating an example operation of the PCB 1000 illustrated in FIGS. 10 and 11, according to aspects of the disclosure. As shown in FIGS. 10-12, the PCMIC 1060 reads the output from the multiple thermistors 1070 at a given time instance through, for example, different GPIOs (as shown in FIG. 11). The PCMIC 1060 feeds the output from the multiple thermistors 1070 to the XO manager 1050 and the block 1090 for computing the (n+m)th derivative. The block 1090 for computing the (n+m)th derivative computes the (n+m)th derivative to identify the true worst thermal transient. The output from the multiple thermistors 1070 is also input to the OTFTM block 1080, the operation of which is discussed further below.

Referring to the block 1090 for computing the (n+m)th derivative in greater detail, n is a thermal characteristic (e.g., XO thermal slope in d/s) and is a parameter used to gauge the impact of thermal transient on the XTAL. n+1 is the second derivative of the thermal characteristic, which, where the thermal characteristic is thermal slope, would be thermal acceleration in d/s/s. n+2 is the third derivative of the thermal characteristic, which, where the thermal characteristic is thermal slope, would be thermal jerk in d/s/s/s. n+m is the m-th derivative of the thermal characteristic. The parameter m may be any positive integer.

When two or more thermal aggressors are indicating similar magnitude of thermal aggression (e.g., similar magnitudes of the thermal characteristic), the described approach can be used to distinguish the true thermal aggressor and hence the true worst thermal transient, which is further used as an input by the OTFTM block 1080 to suppress the impact of the identified worst thermal aggressor. For example, where the thermal characteristic is XO thermal slope, the thermal slope for a first thermal aggressor (e.g., an LTE power amplifier) may be 0.6 degrees Celsius per second (degC/s) and the thermal slope for a second thermal aggressor (e.g., an application processor) may also be 0.6 degC/s. In this case, the true thermal aggressor cannot be determined because both thermal aggressors are indicating the same magnitude of XO thermal slope.

Accordingly, the block 1090 for computing the (n+m)th derivative can determine the first derivative of the thermal characteristic, here, XO thermal acceleration in degrees Celsius per second per second (degC/s/s). In this example, the thermal acceleration may also indicate a similar magnitude of 1.4 degC/s/s for both thermal aggressors. As such, block 1090 for computing the (n+m)th derivative can determine the jerk in degrees Celsius per second per second per second (degC/s/s/s). In the present example, the first thermal aggressor may be determined to have a jerk magnitude of 0.8 degC/s/s/s and the second thermal aggressor may be determined to have a magnitude of 0.4 degC/s/s/s. Based on these values, the block 1090 for computing the (n+m)th derivative determines that the first thermal aggressor (e.g., the LTE power amplifier) is the true thermal aggressor. This example is illustrated in the following table.

TABLE 2

| | First Thermal | Second Thermal |
|---|---|---|
| Parameter | Aggressor | Aggressor |
| XO thermal slope | 0.6 | 0.6 |
| (degC./s) | | |
| XO thermal acceleration | 1.4 | 1.4 |
| (degC./s/s) | | |
| XO thermal jerk | 0.8 | 0.4 |
| (degC./s/s/s) | | |
| (n + m)th derivative | | |
| (degC./s/s/s/ . . . /sₘ | | |

Thus, as shown, the m-th derivative of the XO thermal slope (or other thermal characteristic) can be determined for all values of m until the true thermal aggressor is determined.

Referring to the OTFTM block 1080 in greater detail, on-the-fly thermal mitigation is a method to aid XO thermal recovery by suppressing the thermal aggressor under the given performance constraints and thereby improving the user navigation experience (due to the improvement to the frequency error correction applied to the satellite signal receiver). Referring to the thermal slope derivative example described above and summarized in Table 2, it was determined that the first thermal aggressor (e.g., the LTE power amplifier) was the true worst thermal aggressor because its XO thermal jerk value was 0.8 degC/s/s/s, whereas the XO thermal jerk value of the second thermal aggressor (e.g., the application processor) was 0.4 degC/s/s/s. This output can further be used as an input to the OTFTM block 1080 to suppress the thermal aggression of the first thermal aggressor.

For example, for an LTE power amplifier, typically, the more current that is drawn the more heat that is generated. As such, to suppress/reduce the heat generated by the LTE power amplifier, the LTE transmit power can be reduced, which reduces the current consumption and hence the heat generated. This can be accomplished by consistently maintaining the RF performance key performance indicators (KPIs), such as maintaining a reliable cellular link, electro-magnetic compatibility (EMC) constraints, etc. Similar techniques can be used to suppress the thermal aggression of the application processor (where it is the worst thermal aggressor), such as switching to low power mode, reducing the number of processing threads, etc.

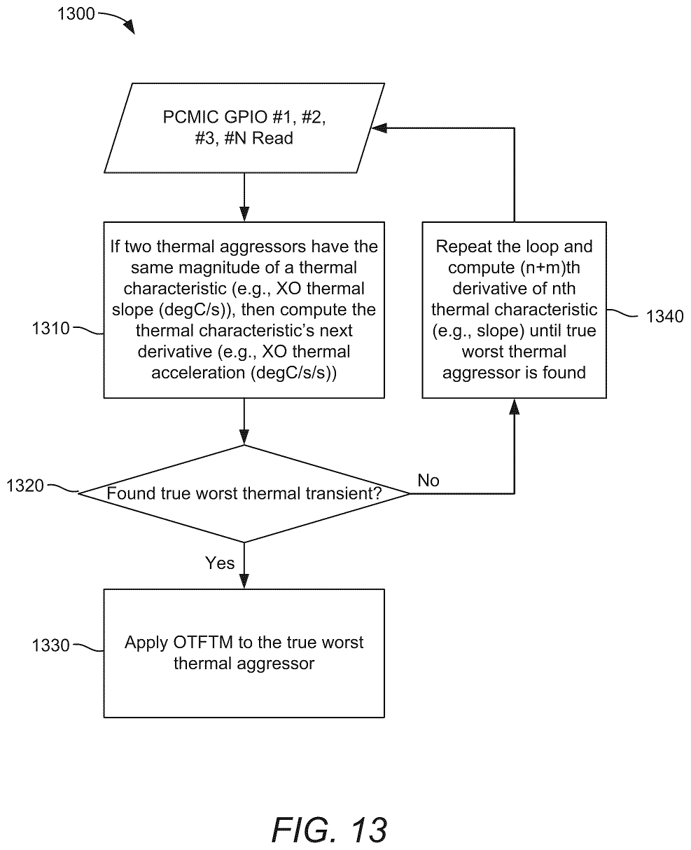

FIG. 13 is a diagram 1300 illustrating an example operation of the block 1090 for computing the (n+m)th derivative and the OTFTM block 1080 in FIG. 10, according to aspects of the disclosure. As shown in FIG. 13, at block 1310, if two thermal aggressors have the same magnitude of a thermal characteristic (e.g., XO thermal slope (degC/s)), then the block 1090 for computing the (n+m)th derivative computes the thermal characteristic's next derivative (e.g., XO thermal acceleration (degC/s/s)). At block 1320, the block 1090 for computing the (n+m)th derivative determines whether the true worst thermal transient has been found. If it has, then at block 1330, the OTFTM block 1080 applies on-the-fly thermal mitigation (OTFTM) to the true worst thermal aggressor. If the true worst thermal transient has not been found, then at block 1340, the block 1090 for computing the (n+m)th derivative repeats the loop and computes the (n+m)th derivative of the n-th thermal characteristic (e.g., slope) until true worst thermal aggressor is found at block 1320.

As will be appreciated, an advantage of the proposed (n+m)th derivative approach is that the true worst thermal aggressor can be identified and the impact of thermal transients on the XO can be evaluated. The true worst thermal aggressor's thermal indicator can then be used as an input to the OTFTM block to suppress the thermal aggressor under the given performance constraints. This can improve the accuracy of the frequency error correction and thereby improve GNSS navigation performance.

As will be further appreciated, the disclosed techniques can be deployed in any handheld user device with multiple thermal aggressors (e.g., application processor, power amplifier, baseband processing unit, camera, display unit, etc.) that could thermally impact GNSS performance. More generally, the disclosed techniques may be deployed in any user application where frequency error results from thermal transients. Further, the disclosed techniques are not limited to handheld user devices, but rather, apply to any device that includes components where frequency error may result from the thermal transients of multiple thermal aggressors. For example, the disclosed techniques may be deployed in location technologies, automotive applications, etc.

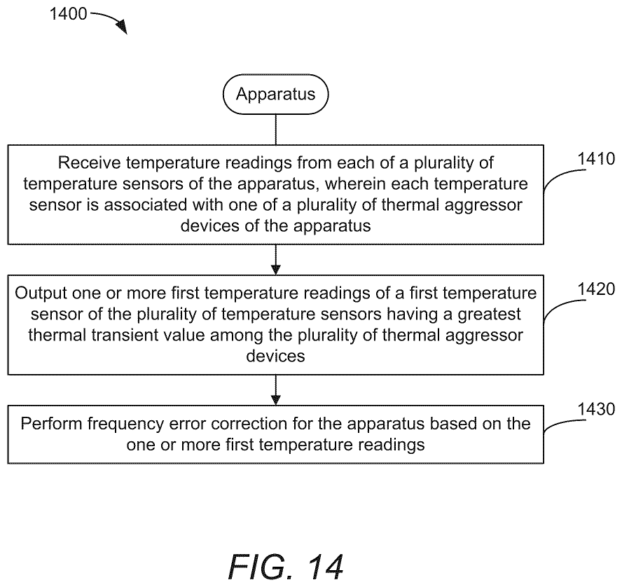

FIG. 14 illustrates an example method 1400 of frequency error correction, according to aspects of the disclosure. In an aspect, method 1400 may be performed by one or more circuits of an apparatus, a clock circuit (e.g., XTAL 640, XTAL 1040), a power and clock management circuit (e.g., PCMIC 660, PCMIC 1060), a clock manager circuit (e.g., XO manager 650, XO manager 1050), a dynamic switching circuit (e.g., dynamic switching block 680), an OTFTM circuit (e.g., OTFTM block 1080), a derivative computation circuit (e.g., block 1090 for computing the (n+m)th derivative), or any combination thereof. These circuits, either alone or in combination, may be considered means for performing the following operations.

At operation 1410, the one or more circuits, either alone or in combination, receive temperature readings from each of a plurality of temperature sensors (e.g., thermistors 670, thermistors 1070) of the apparatus (e.g., PCB 600, PCB 1000), wherein each temperature sensor is associated with one of a plurality of thermal aggressor devices (e.g., thermal aggressors 620, thermal aggressors 1020) of the apparatus.

At operation 1420, the one or more circuits, either alone or in combination, output one or more first temperature readings of a first temperature sensor of the plurality of temperature sensors having a greatest thermal transient value among the plurality of thermal aggressor devices.

At operation 1430, the one or more circuits, either alone or in combination, perform frequency error correction for the apparatus based on the one or more first temperature readings.

As will be appreciated, a technical advantage of the method 1400 is that the true worst thermal aggressor can be identified and the impact of thermal transients can be evaluated and addressed (e.g., by performing frequency error correction for the apparatus based on the one or more first temperature readings).

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. An apparatus, comprising: one or more circuits, the one or more circuits, either alone or in combination, configured to: receive temperature readings from each of a plurality of temperature sensors of the apparatus, wherein each temperature sensor is associated with one of a plurality of thermal aggressor devices of the apparatus; output one or more first temperature readings of a first temperature sensor of the plurality of temperature sensors having a greatest thermal transient value among the plurality of thermal aggressor devices; and perform frequency error correction for the apparatus based on the one or more first temperature readings.

Clause 2. The apparatus of clause 1, wherein the one or more circuits, either alone or in combination, are further configured to: determine a thermal transient value of each of the plurality of temperature sensors based on one or more thermal characteristics of each of the plurality of temperature sensors; and determine that the first temperature sensor has the greatest thermal transient value based on the one or more thermal characteristics of the first temperature sensor.

Clause 3. The apparatus of clause 2, wherein the one or more circuits, either alone or in combination, are configured to determine the one or more thermal characteristics of each of the plurality of thermal aggressor devices based on the temperature readings from each of the plurality of temperature sensors.

Clause 4. The apparatus of any of clauses 2 to 3, wherein the one or more circuits, either alone or in combination, are further configured to determine the one or more thermal characteristics of each of the plurality of temperature sensors.

Clause 5. The apparatus of any of clauses 2 to 4, wherein the one or more thermal characteristics comprise: a temperature, a thermal slope, a thermal acceleration, or any combination thereof.

Clause 6. The apparatus of any of clauses 2 to 5, wherein the one or more thermal characteristics comprise: a first thermal characteristic, and one or more derivatives of the first thermal characteristic.

Clause 7. The apparatus of clause 6, wherein, based on at least two of the plurality of thermal aggressor devices having a same value of the first thermal characteristic, a thermal aggressor device of the at least two of the plurality of thermal aggressor devices having a greater value of the one or more derivatives is determined to be a greater thermal aggressor device of the at least two of the plurality of thermal aggressor devices.

Clause 8. The apparatus of any of clauses 6 to 7, wherein, based on at least two of the plurality of thermal aggressor devices having a same value of the first thermal characteristic and a first derivative of the first thermal characteristic, a thermal aggressor device of the at least two of the plurality of thermal aggressor devices having a greater value of a second derivative of the first thermal characteristic is determined to be a greater thermal aggressor device of the at least two of the plurality of thermal aggressor devices.

Clause 9. The apparatus of any of clauses 6 to 8, wherein the first characteristic is thermal slope.

Clause 10. The apparatus of any of clauses 1 to 9, wherein the one or more circuits, either alone or in combination, are further configured to: iterate over the temperature readings from each of the plurality of temperature sensors until the first temperature sensor having the greatest thermal transient value among the plurality of thermal aggressor devices is determined.

Clause 11. The apparatus of any of clauses 1 to 10, wherein the one or more circuits, either alone or in combination, are further configured to: receive second temperature readings from each of the plurality of temperature sensors; output one or more second temperature readings of a second temperature sensor of the plurality of temperature sensors having a greatest thermal transient value among the plurality of thermal aggressor devices; and perform frequency error correction for the apparatus based on the one or more second temperature readings.

Clause 12. The apparatus of any of clauses 1 to 11, wherein the plurality of thermal aggressor devices comprises a plurality of devices that cause frequency drift to a clock circuit of the apparatus.

Clause 13. The apparatus of any of clauses 1 to 12, wherein the plurality of thermal aggressor devices comprises a plurality of devices that impact global navigation satellite system (GNSS) performance.

Clause 14. The apparatus of any of clauses 1 to 13, wherein the plurality of thermal aggressor devices comprises: one or more application processors, one or more power amplifiers, one or more baseband processing units, one or more cameras, one or more display units, or any combination thereof.

Clause 15. The apparatus of any of clauses 1 to 14, wherein the one or more circuits comprise: a clock circuit, a power and clock management circuit, a clock manager circuit, or any combination thereof.

Clause 16. The apparatus of any of clauses 1 to 15, wherein the apparatus comprises a handheld wireless device or a circuit board within the handheld wireless device.

Clause 17. A method performed by one or more circuits, either alone or in combination, of an apparatus, comprising: receiving temperature readings from each of a plurality of temperature sensors of the apparatus, wherein each temperature sensor is associated with one of a plurality of thermal aggressor devices of the apparatus; outputting one or more first temperature readings of a first temperature sensor of the plurality of temperature sensors having a greatest thermal transient value among the plurality of thermal aggressor devices; and performing frequency error correction for the apparatus based on the one or more first temperature readings.

Clause 18. The method of clause 17, further comprising: determining a thermal transient value of each of the plurality of temperature sensors based on one or more thermal characteristics of each of the plurality of temperature sensors; and determining that the first temperature sensor has the greatest thermal transient value based on the one or more thermal characteristics of the first temperature sensor.

Clause 19. The method of clause 18, further comprising: determining the one or more thermal characteristics of each of the plurality of thermal aggressor devices based on the temperature readings from each of the plurality of temperature sensors.

Clause 20. The method of any of clauses 18 to 19, further comprising: determining the one or more thermal characteristics of each of the plurality of temperature sensors.

Clause 21. The method of any of clauses 18 to 20, wherein the one or more thermal characteristics comprise: a temperature, a thermal slope, a thermal acceleration, or any combination thereof.

Clause 22. The method of any of clauses 18 to 21, wherein the one or more thermal characteristics comprise: a first thermal characteristic, and one or more derivatives of the first thermal characteristic.

Clause 23. The method of clause 22, wherein, based on at least two of the plurality of thermal aggressor devices having a same value of the first thermal characteristic, a thermal aggressor device of the at least two of the plurality of thermal aggressor devices having a greater value of the one or more derivatives is determined to be a greater thermal aggressor device of the at least two of the plurality of thermal aggressor devices.

Clause 24. The method of any of clauses 22 to 23, wherein, based on at least two of the plurality of thermal aggressor devices having a same value of the first thermal characteristic and a first derivative of the first thermal characteristic, a thermal aggressor device of the at least two of the plurality of thermal aggressor devices having a greater value of a second derivative of the first thermal characteristic is determined to be a greater thermal aggressor device of the at least two of the plurality of thermal aggressor devices.

Clause 25. The method of any of clauses 22 to 24, wherein the first characteristic is thermal slope.

Clause 26. The method of any of clauses 17 to 25, further comprising: iterating over the temperature readings from each of the plurality of temperature sensors until the first temperature sensor having the greatest thermal transient value among the plurality of thermal aggressor devices is determined.

Clause 27. The method of any of clauses 17 to 26, further comprising: receiving second temperature readings from each of the plurality of temperature sensors; outputting one or more second temperature readings of a second temperature sensor of the plurality of temperature sensors having a greatest thermal transient value among the plurality of thermal aggressor devices; and performing frequency error correction for the apparatus based on the one or more second temperature readings.

Clause 28. The method of any of clauses 17 to 27, wherein the plurality of thermal aggressor devices comprises a plurality of devices that cause frequency drift to a clock circuit of the apparatus.

Clause 29. The method of any of clauses 17 to 28, wherein the plurality of thermal aggressor devices comprises a plurality of devices that impact global navigation satellite system (GNSS) performance.

Clause 30. The method of any of clauses 17 to 29, wherein the plurality of thermal aggressor devices comprises: one or more application processors, one or more power amplifiers, one or more baseband processing units, one or more cameras, one or more display units, or any combination thereof.

Clause 31. The method of any of clauses 17 to 30, wherein the one or more circuits comprise: a clock circuit, a power and clock management circuit, a clock manager circuit, or any combination thereof.

Clause 32. The method of any of clauses 17 to 31, wherein the apparatus comprises a handheld wireless device or a circuit board within the handheld wireless device.

Clause 33. An apparatus, comprising: means for receiving temperature readings from each of a plurality of temperature sensors of the apparatus, wherein each temperature sensor is associated with one of a plurality of thermal aggressor devices of the apparatus; means for outputting one or more first temperature readings of a first temperature sensor of the plurality of temperature sensors having a greatest thermal transient value among the plurality of thermal aggressor devices; and means for performing frequency error correction for the apparatus based on the one or more first temperature readings.

Clause 34. The apparatus of clause 33, further comprising: means for determining a thermal transient value of each of the plurality of temperature sensors based on one or more thermal characteristics of each of the plurality of temperature sensors; and means for determining that the first temperature sensor has the greatest thermal transient value based on the one or more thermal characteristics of the first temperature sensor.

Clause 35. The apparatus of clause 34, further comprising: means for determining the one or more thermal characteristics of each of the plurality of thermal aggressor devices based on the temperature readings from each of the plurality of temperature sensors.

Clause 36. The apparatus of any of clauses 34 to 35, further comprising: means for determining the one or more thermal characteristics of each of the plurality of temperature sensors.

Clause 37. The apparatus of any of clauses 34 to 36, wherein the one or more thermal characteristics comprise: a temperature, a thermal slope, a thermal acceleration, or any combination thereof.

Clause 38. The apparatus of any of clauses 34 to 37, wherein the one or more thermal characteristics comprise: a first thermal characteristic, and one or more derivatives of the first thermal characteristic.

Clause 39. The apparatus of clause 38, wherein, based on at least two of the plurality of thermal aggressor devices having a same value of the first thermal characteristic, a thermal aggressor device of the at least two of the plurality of thermal aggressor devices having a greater value of the one or more derivatives is determined to be a greater thermal aggressor device of the at least two of the plurality of thermal aggressor devices.

Clause 40. The apparatus of any of clauses 38 to 39, wherein, based on at least two of the plurality of thermal aggressor devices having a same value of the first thermal characteristic and a first derivative of the first thermal characteristic, a thermal aggressor device of the at least two of the plurality of thermal aggressor devices having a greater value of a second derivative of the first thermal characteristic is determined to be a greater thermal aggressor device of the at least two of the plurality of thermal aggressor devices.

Clause 41. The apparatus of any of clauses 38 to 40, wherein the first characteristic is thermal slope.

Clause 42. The apparatus of any of clauses 33 to 41, further comprising: means for iterating over the temperature readings from each of the plurality of temperature sensors until the first temperature sensor having the greatest thermal transient value among the plurality of thermal aggressor devices is determined.

Clause 43. The apparatus of any of clauses 33 to 42, further comprising: means for receiving second temperature readings from each of the plurality of temperature sensors; means for outputting one or more second temperature readings of a second temperature sensor of the plurality of temperature sensors having a greatest thermal transient value among the plurality of thermal aggressor devices; and means for performing frequency error correction for the apparatus based on the one or more second temperature readings.

Clause 44. The apparatus of any of clauses 33 to 43, wherein the plurality of thermal aggressor devices comprises a plurality of devices that cause frequency drift to a clock circuit of the apparatus.

Clause 45. The apparatus of any of clauses 33 to 44, wherein the plurality of thermal aggressor devices comprises a plurality of devices that impact global navigation satellite system (GNSS) performance.

Clause 46. The apparatus of any of clauses 33 to 45, wherein the plurality of thermal aggressor devices comprises: one or more application processors, one or more power amplifiers, one or more baseband processing units, one or more cameras, one or more display units, or any combination thereof.

Clause 47. The apparatus of any of clauses 33 to 46, wherein the apparatus includes one or more circuits comprising: a clock circuit, a power and clock management circuit, a clock manager circuit, or any combination thereof.

Clause 48. The apparatus of any of clauses 33 to 47, wherein the apparatus comprises a handheld wireless device or a circuit board within the handheld wireless device.

Clause 49. A non-transitory computer-readable medium storing computer-executable instructions that, when executed by an apparatus, cause the apparatus to: receive temperature readings from each of a plurality of temperature sensors of the apparatus, wherein each temperature sensor is associated with one of a plurality of thermal aggressor devices of the apparatus; output one or more first temperature readings of a first temperature sensor of the plurality of temperature sensors having a greatest thermal transient value among the plurality of thermal aggressor devices; and perform frequency error correction for the apparatus based on the one or more first temperature readings.

Clause 50. The non-transitory computer-readable medium of clause 49, further comprising computer-executable instructions that, when executed by the apparatus, cause the apparatus to: determine a thermal transient value of each of the plurality of temperature sensors based on one or more thermal characteristics of each of the plurality of temperature sensors; and determine that the first temperature sensor has the greatest thermal transient value based on the one or more thermal characteristics of the first temperature sensor.

Clause 51. The non-transitory computer-readable medium of clause 50, further comprising computer-executable instructions that, when executed by the apparatus, cause the apparatus to: determine the one or more thermal characteristics of each of the plurality of thermal aggressor devices based on the temperature readings from each of the plurality of temperature sensors.

Clause 52. The non-transitory computer-readable medium of any of clauses 50 to 51, further comprising computer-executable instructions that, when executed by the apparatus, cause the apparatus to: determine the one or more thermal characteristics of each of the plurality of temperature sensors.

Clause 53. The non-transitory computer-readable medium of any of clauses 50 to 52, wherein the one or more thermal characteristics comprise: a temperature, a thermal slope, a thermal acceleration, or any combination thereof.

Clause 54. The non-transitory computer-readable medium of any of clauses 50 to 53, wherein the one or more thermal characteristics comprise: a first thermal characteristic, and one or more derivatives of the first thermal characteristic.

Clause 55. The non-transitory computer-readable medium of clause 54, wherein, based on at least two of the plurality of thermal aggressor devices having a same value of the first thermal characteristic, a thermal aggressor device of the at least two of the plurality of thermal aggressor devices having a greater value of the one or more derivatives is determined to be a greater thermal aggressor device of the at least two of the plurality of thermal aggressor devices.

Clause 56. The non-transitory computer-readable medium of any of clauses 54 to 55, wherein, based on at least two of the plurality of thermal aggressor devices having a same value of the first thermal characteristic and a first derivative of the first thermal characteristic, a thermal aggressor device of the at least two of the plurality of thermal aggressor devices having a greater value of a second derivative of the first thermal characteristic is determined to be a greater thermal aggressor device of the at least two of the plurality of thermal aggressor devices.

Clause 57. The non-transitory computer-readable medium of any of clauses 54 to 56, wherein the first characteristic is thermal slope.

Clause 58. The non-transitory computer-readable medium of any of clauses 49 to 57, further comprising computer-executable instructions that, when executed by the apparatus, cause the apparatus to: iterate over the temperature readings from each of the plurality of temperature sensors until the first temperature sensor having the greatest thermal transient value among the plurality of thermal aggressor devices is determined.

Clause 59. The non-transitory computer-readable medium of any of clauses 49 to 58, further comprising computer-executable instructions that, when executed by the apparatus, cause the apparatus to: receive second temperature readings from each of the plurality of temperature sensors; output one or more second temperature readings of a second temperature sensor of the plurality of temperature sensors having a greatest thermal transient value among the plurality of thermal aggressor devices; and perform frequency error correction for the apparatus based on the one or more second temperature readings.

Clause 60. The non-transitory computer-readable medium of any of clauses 49 to 59, wherein the plurality of thermal aggressor devices comprises a plurality of devices that cause frequency drift to a clock circuit of the apparatus.

Clause 61. The non-transitory computer-readable medium of any of clauses 49 to 60, wherein the plurality of thermal aggressor devices comprises a plurality of devices that impact global navigation satellite system (GNSS) performance.

Clause 62. The non-transitory computer-readable medium of any of clauses 49 to 61, wherein the plurality of thermal aggressor devices comprises: one or more application processors, one or more power amplifiers, one or more baseband processing units, one or more cameras, one or more display units, or any combination thereof.

Clause 63. The non-transitory computer-readable medium of any of clauses 49 to 62, wherein the apparatus includes one or more circuits comprising: a clock circuit, a power and clock management circuit, a clock manager circuit, or any combination thereof.

Clause 64. The non-transitory computer-readable medium of any of clauses 49 to 63, wherein the apparatus comprises a handheld wireless device or a circuit board within the handheld wireless device.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. An apparatus, comprising:
one or more circuits, the one or more circuits, either alone or in combination, configured to:
receive temperature readings from each of a plurality of temperature sensors of the apparatus, wherein each temperature sensor is associated with one of a plurality of thermal aggressor devices of the apparatus;
output one or more first temperature readings of a first temperature sensor of the plurality of temperature sensors having a greatest thermal transient value among the plurality of thermal aggressor devices; and
perform frequency error correction for the apparatus based on the one or more first temperature readings.

2. The apparatus of claim 1, wherein the one or more circuits, either alone or in combination, are further configured to:
determine a thermal transient value of each of the plurality of temperature sensors based on one or more thermal characteristics of each of the plurality of temperature sensors; and
determine that the first temperature sensor has the greatest thermal transient value based on the one or more thermal characteristics of the first temperature sensor.

3. The apparatus of claim 2, wherein the one or more circuits, either alone or in combination, are configured to determine the one or more thermal characteristics of each of the plurality of thermal aggressor devices based on the temperature readings from each of the plurality of temperature sensors.

4. The apparatus of claim 2, wherein the one or more circuits, either alone or in combination, are further configured to determine the one or more thermal characteristics of each of the plurality of temperature sensors.

5. The apparatus of claim 2, wherein the one or more thermal characteristics comprise:
a temperature,
a thermal slope,
a thermal acceleration, or
any combination thereof.

6. The apparatus of claim 2, wherein the one or more thermal characteristics comprise:
a first thermal characteristic, and
one or more derivatives of the first thermal characteristic.

7. The apparatus of claim 6, wherein, based on at least two of the plurality of thermal aggressor devices having a same value of the first thermal characteristic, a thermal aggressor device of the at least two of the plurality of thermal aggressor devices having a greater value of the one or more derivatives is determined to be a greater thermal aggressor device of the at least two of the plurality of thermal aggressor devices.

8. The apparatus of claim 6, wherein, based on at least two of the plurality of thermal aggressor devices having a same value of the first thermal characteristic and a first derivative of the first thermal characteristic, a thermal aggressor device of the at least two of the plurality of thermal aggressor devices having a greater value of a second derivative of the first thermal characteristic is determined to be a greater thermal aggressor device of the at least two of the plurality of thermal aggressor devices.

9. The apparatus of claim 6, wherein the first characteristic is thermal slope.

10. The apparatus of claim 1, wherein the one or more circuits, either alone or in combination, are further configured to:
iterate over the temperature readings from each of the plurality of temperature sensors until the first temperature sensor having the greatest thermal transient value among the plurality of thermal aggressor devices is determined.

11. The apparatus of claim 1, wherein the one or more circuits, either alone or in combination, are further configured to:
receive second temperature readings from each of the plurality of temperature sensors;
output one or more second temperature readings of a second temperature sensor of the plurality of temperature sensors having a greatest thermal transient value among the plurality of thermal aggressor devices; and
perform frequency error correction for the apparatus based on the one or more second temperature readings.

12. The apparatus of claim 1, wherein the plurality of thermal aggressor devices comprises a plurality of devices that cause frequency drift to a clock circuit of the apparatus.

13. The apparatus of claim 1, wherein the plurality of thermal aggressor devices comprises a plurality of devices that impact global navigation satellite system (GNSS) performance.

14. The apparatus of claim 1, wherein the plurality of thermal aggressor devices comprises:
one or more application processors,
one or more power amplifiers,
one or more baseband processing units,
one or more cameras,
one or more display units, or
any combination thereof.

15. The apparatus of claim 1, wherein the one or more circuits comprise:
a clock circuit,
a power and clock management circuit,
a clock manager circuit, or
any combination thereof.

16. The apparatus of claim 1, wherein the apparatus comprises a handheld wireless device or a circuit board within the handheld wireless device.

17. A method performed by one or more circuits, either alone or in combination, of an apparatus, comprising:
receiving temperature readings from each of a plurality of temperature sensors of the apparatus, wherein each temperature sensor is associated with one of a plurality of thermal aggressor devices of the apparatus;
outputting one or more first temperature readings of a first temperature sensor of the plurality of temperature sensors having a greatest thermal transient value among the plurality of thermal aggressor devices; and
performing frequency error correction for the apparatus based on the one or more first temperature readings.

18. The method of claim 17, further comprising:
determining a thermal transient value of each of the plurality of temperature sensors based on one or more thermal characteristics of each of the plurality of temperature sensors; and
determining that the first temperature sensor has the greatest thermal transient value based on the one or more thermal characteristics of the first temperature sensor.

19. The method of claim 18, further comprising:
determining the one or more thermal characteristics of each of the plurality of thermal aggressor devices based on the temperature readings from each of the plurality of temperature sensors.

20. The method of claim 18, further comprising:
determining the one or more thermal characteristics of each of the plurality of temperature sensors.

21. The method of claim 18, wherein the one or more thermal characteristics comprise:
a temperature,
a thermal slope,
a thermal acceleration, or
any combination thereof.

22. The method of claim 18, wherein the one or more thermal characteristics comprise:
a first thermal characteristic, and
one or more derivatives of the first thermal characteristic.

23. The method of claim 22, wherein, based on at least two of the plurality of thermal aggressor devices having a same value of the first thermal characteristic, a thermal aggressor device of the at least two of the plurality of thermal aggressor devices having a greater value of the one or more derivatives is determined to be a greater thermal aggressor device of the at least two of the plurality of thermal aggressor devices.

24. The method of claim 22, wherein, based on at least two of the plurality of thermal aggressor devices having a same value of the first thermal characteristic and a first derivative of the first thermal characteristic, a thermal aggressor device of the at least two of the plurality of thermal aggressor devices having a greater value of a second derivative of the first thermal characteristic is determined to be a greater thermal aggressor device of the at least two of the plurality of thermal aggressor devices.

25. The method of claim 22, wherein the first characteristic is thermal slope.

26. The method of claim 17, further comprising:
iterating over the temperature readings from each of the plurality of temperature sensors until the first temperature sensor having the greatest thermal transient value among the plurality of thermal aggressor devices is determined.

27. The method of claim 17, further comprising:
receiving second temperature readings from each of the plurality of temperature sensors;
outputting one or more second temperature readings of a second temperature sensor of the plurality of temperature sensors having a greatest thermal transient value among the plurality of thermal aggressor devices; and
performing frequency error correction for the apparatus based on the one or more second temperature readings.

28. The method of claim 17, wherein the plurality of thermal aggressor devices comprises a plurality of devices that cause frequency drift to a clock circuit of the apparatus.

29. An apparatus, comprising:
means for receiving temperature readings from each of a plurality of temperature sensors of the apparatus, wherein each temperature sensor is associated with one of a plurality of thermal aggressor devices of the apparatus;
means for outputting one or more first temperature readings of a first temperature sensor of the plurality of temperature sensors having a greatest thermal transient value among the plurality of thermal aggressor devices; and
means for performing frequency error correction for the apparatus based on the one or more first temperature readings.

30. A non-transitory computer-readable medium storing computer-executable instructions that, when executed by an apparatus, cause the apparatus to:
receive temperature readings from each of a plurality of temperature sensors of the apparatus, wherein each temperature sensor is associated with one of a plurality of thermal aggressor devices of the apparatus;
output one or more first temperature readings of a first temperature sensor of the plurality of temperature sensors having a greatest thermal transient value among the plurality of thermal aggressor devices; and
perform frequency error correction for the apparatus based on the one or more first temperature readings.
